(19) United States
(12) Patent Application Publication
(10) Pub. No.: US 2014/0247244 A1
(43) Pub. Date: Sep. 4, 2014

(54) CAPACITIVE TOUCH SCREEN AND CONTROL METHOD THEREOF

(71) Applicant: NOVATEK Microelectronics Corp., Hsin-Chu (TW)

(72) Inventors: Shun-Li Wang, Hsinchu City (TW); Chih-Chang Lai, Taichung City (TW); He-Wei Huang, Hsinchu City (TW)

(73) Assignee: NOVATEK Microelectronics Corp., Hsin-Chu (TW)

(21) Appl. No.: 13/967,323

(22) Filed: Aug. 14, 2013

(30) Foreign Application Priority Data
Mar. 4, 2013 (TW) 102107513

(51) Int. Cl. G06F 3/044

(52) U.S. Cl. CPC G06F 3/044
USPC 345/174

(57) ABSTRACT

A capacitive touch screen includes a plurality of touch sensing electrodes and a touch controller. Each of the plurality of touch sensing electrodes includes at least one driving area and at least one receiving area. The at least one driving area and the at least one receiving area are located in a same layer of the capacitive touch screen. The touch controller, electrically connected to the at least one driving area and the at least one receiving area in the plurality of touch sensing electrodes, is utilized for scanning the at least one driving area in order and detecting signals received by the at least one receiving area, or scanning the at least one receiving area in order and detecting signals received by the at least one driving area.

### BACKGROUND OF THE INVENTION

1. Field of the Invention

The present invention relates to a capacitive touch screen and a control method thereof, and more particularly, to a mutual capacitive touch screen and a control method where driving areas and receiving areas in touch sensing electrodes are disposed in the same layer of the touch screen.

2. Description of the Prior Art

In recent years, touch sensing technology advances rapidly, and many consumer electronic products such as mobile phones, GPS navigator systems, tablets, personal digital assistants (PDA) and laptops are equipped with touch sensing functions. In various electronic products, touch sensing functions are included in a display area which originally had only display functions. In other words, an original display panel is replaced by a touch screen capable of both display and touch sensing functions. The touch screen can generally be divided into out-cell, in-cell and on-cell touch screen according to the difference in structure of the touch screen. The out-cell touch screen is composed of an independent touch screen and a general display panel. In the in-cell and on-cell touch screen, a touch sensing device is directly disposed on inside and outside of a substrate in the display panel, respectively.

On the other hand, touch sensing techniques can be classified into a resistive type, capacitive type and optical type. The capacitive type touch screens became popular gradually since they have many advantages such as high sensing accuracy, high transparency, high reaction speed and long life. The capacitive touch screens can further be classified into two types: self capacitance and mutual capacitance. The self capacitive touch screens cannot sense a multi-touch accurately, and are usually applied in electronic products with only single-touch sensing functions or devices with smaller display areas. In comparison, the mutual capacitive touch screens are capable of performing multi-touch sensing functions and other complex touch sensing functions for larger display areas. In the available mutual capacitive touch screens, however, the touch sensing electrodes have to be disposed in different layers of the touch screen, in order to detect capacitor variations between two layers of touch sensing electrodes, which increases manufacturing costs and complexity of the mutual capacitive touch screens.

Thus, there is a need to provide a structure of the mutual capacitive touch screen possessing the advantage that the mutual capacitive touch screen can support multi-touch sensing functions with high accuracy, where the manufacturing costs and complexity can be reduced.

### SUMMARY OF THE INVENTION

It is therefore an objective of the present invention to provide a mutual capacitive touch screen and a control method where driving areas and receiving areas in touch sensing electrodes are disposed in the same layer of the touch screen, in order to reduce the manufacturing costs and complexity of the touch screen in addition to supporting multi-touch sensing functions with high accuracy.

The present invention discloses a capacitive touch screen, which comprises a plurality of touch sensing electrodes, each comprising at least one driving area and at least one receiving area; and a touch controller, for scanning the at least one driving area in the plurality of touch sensing electrodes in order and detecting signals received by the at least one receiving area in the plurality of touch sensing electrodes, or scanning the at least one receiving area in the plurality of touch sensing electrodes in order and detecting signals received by the at least one driving area in the plurality of touch sensing electrodes; wherein the at least one driving area and the at least one receiving area in the plurality of touch sensing electrodes are located in a same layer of the capacitive touch screen; wherein each of the at least one driving area in the plurality of touch sensing electrodes is electrically connected to the touch controller respectively, and each of the at least one receiving area in the plurality of touch sensing electrodes is electrically connected to each other and then electrically connected to the touch controller.

The present invention further discloses a control method for a capacitive touch screen. The control method comprises disposing a plurality of touch sensing electrodes in a same layer of the capacitive touch screen, and each of the plurality of touch sensing electrodes comprises at least one driving area and at least one receiving area; electrically connecting each of the at least one driving area in the plurality of touch sensing electrodes to a touch controller respectively, and electrically connecting each of the at least one receiving area in the plurality of touch sensing electrodes to each other and then electrically connecting the at least one driving area to the touch controller; and scanning the at least one driving area in the plurality of touch sensing electrodes in order and detecting signals received by the at least one receiving area in the plurality of touch sensing electrodes by the touch controller, or scanning the at least one receiving area in the plurality of touch sensing electrodes in order and detecting signals received by the at least one driving area in the plurality of touch sensing electrodes by the touch controller.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional diagram of a liquid crystal display panel according to an embodiment of the present invention.

FIG. 2 is a schematic diagram of a structure of touch sensing electrodes in a touch screen according to an embodiment of the present invention.

FIG. 3 is a schematic diagram of touch sensing electrodes and connecting wires realized behind a black matrix layer.

FIG. 4 is a schematic diagram of a structure of touch sensing electrodes in a touch screen according to an embodiment of the present invention.

FIG. 5 is a schematic diagram of a structure of touch sensing electrodes in a touch screen according to an embodiment of the present invention.

### DETAILED DESCRIPTION

Distinct from conventional mutual capacitive touch screens where the driving areas and receiving areas in touch sensing electrodes are disposed in two different layers to perform touch sensing by detecting capacitance variations between these two layers, the present invention simplifies the two layers of touch sensing electrodes to one layer, where the advantage that the mutual capacitive touch screens can detect multi-touch accurately still remains.

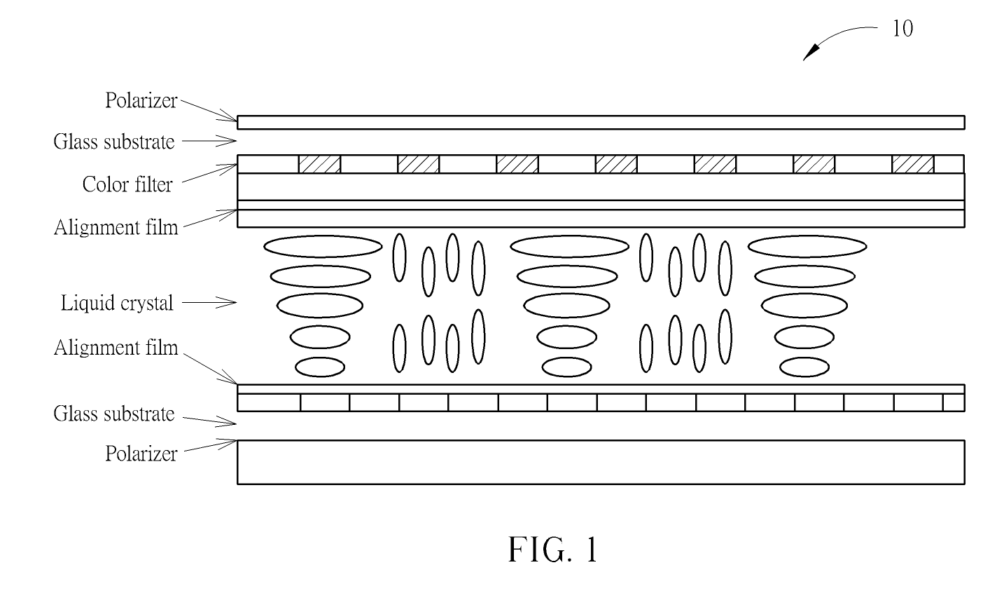

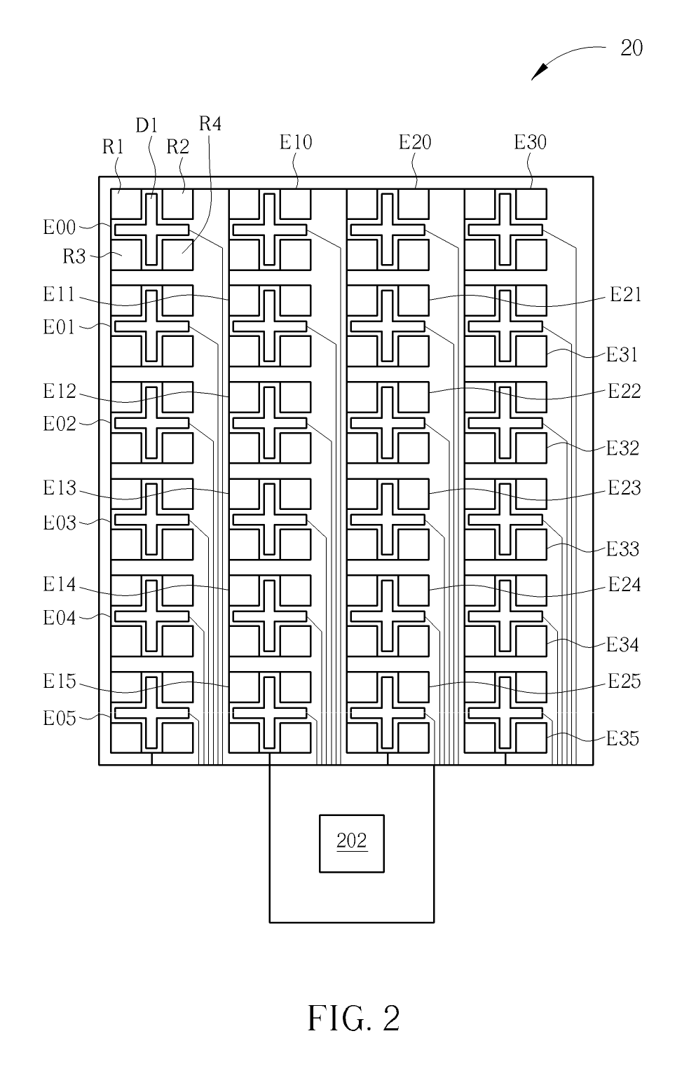

Please refer to FIG. 1, which is a cross-sectional diagram of a liquid crystal display (LCD) panel 10 according to an embodiment of the present invention. As shown in FIG. 1, the LCD panel 10 includes layers such as polarizers, glass substrates, a color filter, alignment films and liquid crystal. In order to realize built-in touch sensing functions, touch sensing electrodes can be disposed in any layer of the LCD panel 10. For example, the touch sensing electrodes may be a plurality of transparent indium tin oxide (ITO) electrodes disposed on an upper glass substrate or a lower glass substrate to form a plurality of independent touch sensing areas. Otherwise, the touch sensing electrodes may be disposed behind a black matrix (BM) layer of the color filter layer to form a plurality of independent touch sensing areas by using metal wires. One of the detailed embodiments is illustrated in FIG. 2.

FIG. 2 is a schematic diagram of a structure of touch sensing electrodes in a touch screen 20 according to an embodiment of the present invention. As shown in FIG. 2, the touch screen 20 includes twenty-four touch sensing electrodes E00-E35, which are quadrangular electrodes disposed in the touch screen 20 in a 4×6 matrix form. Each of the touch sensing electrodes E00-E35 is independent and has one crisscross driving area and four quadrangular receiving areas. Take the touch sensing electrode E00 as an example. The touch sensing electrode E00 has one crisscross driving area D1 with its center coincided with the center of the touch sensing electrode E00, and four quadrangular receiving areas R1-R4, one of which is located in each of four corners of the touch sensing electrode E00 respectively. Touch sensing signals received by the touch sensing electrodes E00-E35 are controlled by a touch controller 202. The touch controller 202 can be, for example, a touch controller integrated circuit (IC), which is utilized for detecting the touch signals received by the touch sensing electrodes E00-E35, in order to convert the touch signals in the touch screen 20 into instructions readable by the system. The driving area in each of the touch sensing electrodes E00-E35 is electrically connected to the touch controller 202 respectively, and each of the receiving areas in the touch sensing electrodes E00-E35 is electrically connected to each other and then electrically connected to the touch controller 202.

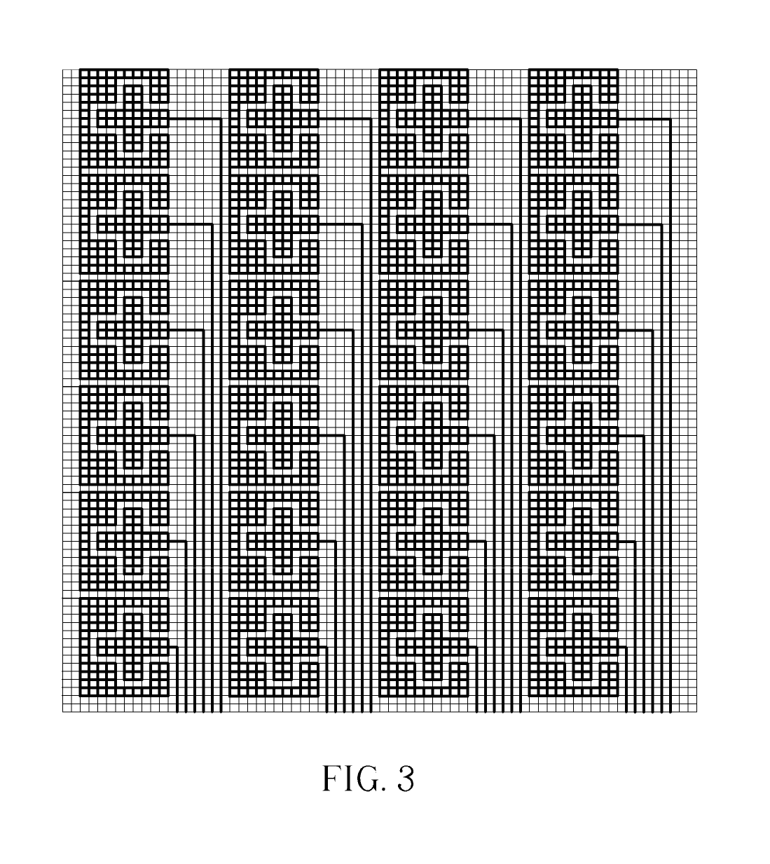

An exemplary embodiment of wire connection for the driving areas and receiving areas is also detailed in FIG. 2. The touch controller 202 is located below the touch screen 20 . Hence, the driving area in each of the touch sensing electrodes E00-E35 is connected to the touch controller 202 via a vertical wire respectively. Four receiving areas in each of the touch sensing electrodes E00-E35 are first connected to each other within each of the touch sensing electrodes E00-E35 via wires. The receiving areas in the touch sensing electrodes E00-E35 located in the same vertical axis are electrically connected to each other, and further electrically connected to the touch controller 202 at the bottom. These receiving areas are also connected at the topmost row via a horizontal wire. In general, the wires utilized for the electrical connection is realized by a transparent material, in order to prevent the wires from affecting the image display of the touch screen 20. As mentioned above, the touch sensing electrodes may also be disposed behind the BM layer, so that metal wires may be utilized to form a plurality of independent touch sensing areas. In such a condition, the metal wires may be disposed behind non-transparent materials according to the disposition of light shield materials in the BM layer, which allows the touch signals to be transmitted without affecting the image display. Please refer to FIG. 3, which is a schematic diagram of touch sensing electrodes and connecting wires realized behind the BM layer. As shown in FIG. 3, the touch sensing electrodes and the connecting wires are both disposed behind non-transparent materials. Therefore, these touch sensing electrodes and wires will not affect the image display, so that transparent materials may not be required.

When the touch screen is operated, the touch controller 202 scans all driving areas in the touch sensing electrodes E00-E35 in order, and detects signals received by all receiving areas in the touch sensing electrodes E00-E35. For example, according to the disposition of the touch sensing electrodes E00-E35 in the touch screen 20, the touch controller 202 may detect signals from six receiving areas. After detecting four times, the touch controller 202 obtains complete capacitance variations of the 4×6 touch sensing electrodes. A logic computing device can then be utilized for calculating the location of touch gesture by interpolation according to the capacitance variations of the 4×6 touch sensing electrodes. In general, whether a touch gesture occurs can be determined according to capacitance variations of all touch sensing electrodes, i.e. capacitance variations between the driving areas and the receiving areas. When any capacitance variation exceeds a predetermined value, the touch controller 202 may determine that a touch gesture occurs. The location of touch gesture is then calculated by interpolation according to capacitance variations of all touch sensing electrodes on the basis of a touch sensing electrode having a maximum capacitance variation. The calculating method of interpolation should be well-known by those skilled in the art, and is not narrated herein.

In some embodiments, the structure of the touch screen 20 may be adjusted by external circuits to be adapted to various applications. For example, a driving terminal of the external circuit may be connected to the receiving areas of the touch sensing electrodes E00-E35, and a receiving terminal of the external circuit may be connected to the driving areas of the touch sensing electrodes E00-E35. As a result, the touch controller 202 scans all receiving areas in the touch sensing electrodes E00-E35 in order, and detects signals received by all driving areas in the touch sensing electrodes E00-E35. In other words, the functions of the driving areas and the receiving areas in the touch screen 20 are interchanged. According to different system applications, any control method such as driving method and detecting method based on the structure of the touch screen 20 is included in the scope of the present invention.

Please note that according to the present invention, the driving areas and receiving areas in the touch sensing electrodes are disposed in the same layer of the touch screen, in order to reduce the manufacturing costs and complexity of the conventional mutual capacitive touch screens, in which driving areas and receiving areas are disposed in multiple layers. Those skilled in the art can make modifications and alterations accordingly. For example, the number and the disposition of the touch sensing electrodes in the touch screen can be selected arbitrarily. In each touch sensing electrode, the number and the disposition of the driving areas and receiving areas can also be arranged in any manner, which are not limited herein. Besides, the shape of the driving areas and receiving areas may not limited to those shown in FIG. 2, and may be in any shape. Moreover, for each kind of shape and disposition of the touch sensing electrodes, different wire connections may also be applied according to system requirements. In short, as long as all driving areas and all receiving areas in the touch sensing electrodes are located in the same layer of the touch screen, any shape and number of touch sensing electrodes, driving areas or receiving areas, or any wire connection and disposition are all included in the scope of the present invention.

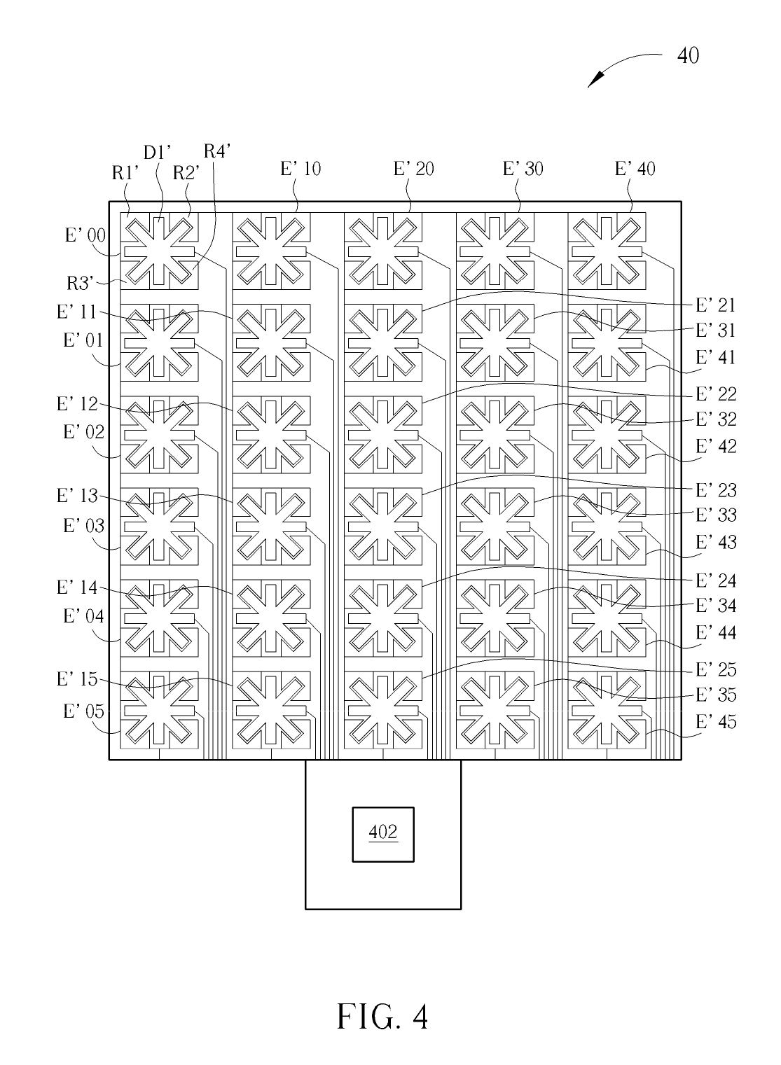

For example, the driving areas and receiving areas with different shapes or dispositions may lead to different sensitivity. In order to achieve higher sensitivity, the disposition of the driving areas and receiving areas can be varied, which enhances capacitive sensing capability. Please refer to FIG. 4, which is a schematic diagram of a structure of touch sensing electrodes in a touch screen 40 according to an embodiment of the present invention. As shown in FIG. 4, the touch screen 40 includes thirty touch sensing electrodes E′00-E′45, which are quadrangular electrodes disposed in the touch screen 40 in a 5×6 matrix form. Each of the touch sensing electrodes E′00-E′45 is independent and has one driving area and four receiving areas. Take the touch sensing electrode E′00 as an example. The touch sensing electrode E′00 has one driving area D1′ including two crisscross driving areas, each of which has a center offset from each other by 45 degrees relative to a major axis of the two crisscross driving areas. The touch sensing electrode E′00 further includes four receiving areas R1′-R4′, and one of the receiving areas R1′-R4′ is located in each of four corners of touch sensing electrode E′00 respectively and surrounds one of four terminals located in the four corners of the touch sensing electrode E′00 among eight terminals of the driving area D1′. Since the receiving areas surround parts of terminals of the driving area, the capacitive sensing capability between the driving area and the receiving areas will be stronger, so that higher touch sensitivity can be achieved in the touch screen 40. Similarly, touch sensing signals received by the touch sensing electrodes E′00-E′45 are controlled by a touch controller 402. For example, according to the disposition of the touch sensing electrodes E′00-E′45 in the touch screen 40, the touch controller 402 may detect signals from six receiving areas. After detecting five times, the touch controller 402 may obtain complete capacitance variations of the 5×6 touch sensing electrodes. A logic computing device can then be utilized for calculating the location of touch gesture by interpolation according to the capacitance variations of the 5×6 touch sensing electrodes.

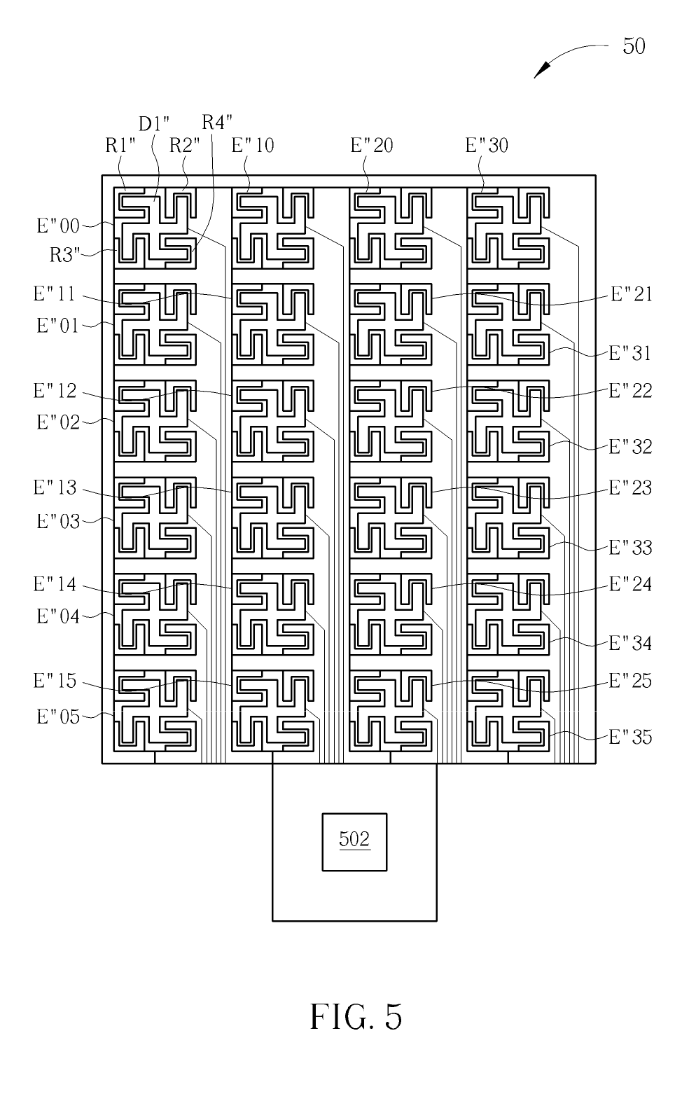

Please refer to FIG. 5, which is a schematic diagram of a structure of touch sensing electrodes in a touch screen 50 according to an embodiment of the present invention. As shown in FIG. 5, the touch screen 50 includes twenty-four touch sensing electrodes E″00-E″35, which are quadrangular electrodes disposed in the touch screen 50 in a 4×6 matrix form. Each of the touch sensing electrodes E″00-E″35 is independent and has one driving area and four receiving areas. Take the touch sensing electrode E′00 as an example. The touch sensing electrode E″00 has one driving area D1″ including a crisscross driving area, and each terminal of the crisscross driving area is extended to the same side of its corresponding terminal respectively. The touch sensing electrode E″00 further includes four receiving areas R1″-R4″, and one of the receiving areas R1″-R4″ is located in one of four corners of the touch sensing electrode E′00 and surrounds an extended terminal of the driving area D1″ respectively. Since the receiving areas surround the terminals of the driving area, the capacitive sensing capability between the driving area and the receiving areas will be stronger, so that higher touch sensitivity can be achieved in the touch screen 50. Similarly, touch sensing signals received by the touch sensing electrodes E″00-E″35 are controlled by a touch controller 502. For example, according to the disposition of the touch sensing electrodes E″00-E″35 in the touch screen 50, the touch controller 502 may detect signals from six receiving areas. After detecting four times, the touch controller 502 may obtain complete capacitance variations of the 4×6 touch sensing electrodes. A logic computing device can then be utilized for calculating the location of touch gesture by interpolation according to the capacitance variations of the 4×6 touch sensing electrodes.

In the prior art, the touch sensing electrodes have to be disposed in different layers of the conventional mutual capacitive touch screens, in order to detect capacitor variations between two layers of touch sensing electrodes, which increases manufacturing costs and complexity of the mutual capacitive touch screens. In comparison, according to the embodiments of the present invention, the driving areas and receiving areas in the touch sensing electrodes are disposed in the same layer of the mutual capacitive touch screen, so that the manufacturing costs and complexity can be reduced. The advantage that the mutual capacitive touch screens can detect multi-touch accurately still remains.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A capacitive touch screen, comprising:
a plurality of touch sensing electrodes, each comprising at least one driving area and at least one receiving area; and
a touch controller, for scanning the at least one driving area in the plurality of touch sensing electrodes in order and detecting signals received by the at least one receiving area in the plurality of touch sensing electrodes, or scanning the at least one receiving area in the plurality of touch sensing electrodes in order and detecting signals received by the at least one driving area in the plurality of touch sensing electrodes;
wherein the at least one driving area and the at least one receiving area in the plurality of touch sensing electrodes are located in a same layer of the capacitive touch screen;
wherein each of the at least one driving area in the plurality of touch sensing electrodes is electrically connected to the touch controller respectively, and each of the at least one receiving area in the plurality of touch sensing electrodes is electrically connected to each other and then electrically connected to the touch controller.

2. The capacitive touch screen of claim 1, wherein each of the plurality of touch sensing electrodes is a quadrangular electrode, of which the at least one driving area comprises a crisscross driving area, and the at least one receiving area comprises four quadrangular receiving areas, one of the four quadrangular receiving areas located in each of four corners of the quadrangular electrode respectively.

3. The capacitive touch screen of claim 1, wherein each of the plurality of touch sensing electrodes is a quadrangular electrode, of which the at least one driving area comprises two crisscross driving areas, each having a center offset from each other by 45 degrees relative to a major axis of the two crisscross driving areas, and the at least one receiving area comprises four receiving areas, one of the four receiving areas located in each of four corners of the quadrangular electrode respectively and surrounding one of four terminals located in the four corners of the quadrangular electrode among eight terminals of the at least one driving area.

4. The capacitive touch screen of claim 1, wherein each of the plurality of touch sensing electrodes is a quadrangular electrode, of which the at least one driving area comprises a crisscross driving area and each terminal of the crisscross driving area is extended to a same side of the terminal respectively, and the at least one receiving area comprises four receiving areas, one of the four receiving areas surrounding an extended terminal of the crisscross driving area respectively.

5. The capacitive touch screen of claim 1, wherein the touch controller is electrically connected to the at least one driving area and the at least one receiving area in the plurality of touch sensing electrodes with metal wires when the plurality of touch sensing electrodes are located behind a black matrix layer.

6. The capacitive touch screen of claim 1, wherein the touch controller detects a capacitance variation between the at least one driving area and the at least one receiving area in each of the plurality of touch sensing electrodes, in order to determine whether a touch gesture occurs and a location of the touch gesture .

7. The capacitive touch screen of claim 6, wherein when the capacitance variation exceeds a predetermined value, the touch controller determines that the touch gesture occurs, and the location of the touch gesture is calculated by interpolation according to capacitance variations in all of the plurality of touch sensing electrodes on the basis of a touch sensing electrode having a maximum capacitance variation among the plurality of touch sensing electrodes.

8. A control method for a capacitive touch screen, comprising:
disposing a plurality of touch sensing electrodes in a same layer of the capacitive touch screen, and each of the plurality of touch sensing electrodes comprising at least one driving area and at least one receiving area;
electrically connecting each of the at least one driving area in the plurality of touch sensing electrodes to a touch controller respectively, and electrically connecting each of the at least one receiving area in the plurality of touch sensing electrodes to each other and then electrically connecting the at least one driving area to the touch controller; and
scanning the at least one driving area in the plurality of touch sensing electrodes in order and detecting signals received by the at least one receiving area in the plurality of touch sensing electrodes by the touch controller, or scanning the at least one receiving area in the plurality of touch sensing electrodes in order and detecting signals received by the at least one driving area in the plurality of touch sensing electrodes by the touch controller.

9. The control method of claim 8, wherein each of the plurality of touch sensing electrodes is a quadrangular electrode, of which the at least one driving area comprises a crisscross driving area, and the at least one receiving area comprises four quadrangular receiving areas, one of the four quadrangular receiving areas located in each of four corners of the quadrangular electrode respectively.

10. The control method of claim 8, wherein each of the plurality of touch sensing electrodes is a quadrangular electrode, of which the at least one driving area comprises two crisscross driving areas, each having a center offset from each other by 45 degrees relative to a major axis of the two crisscross driving areas, and the at least one receiving area comprises four receiving areas, one of the four receiving areas located in each of four corners of the quadrangular electrode respectively and surrounding one of four terminals located in the four corners of the quadrangular electrode among eight terminals of the at least one driving area.

11. The control method of claim 8, wherein each of the plurality of touch sensing electrodes is a quadrangular electrode, of which the at least one driving area comprises a crisscross driving area and each terminal of the crisscross driving area is extended to a same side of the terminal respectively, and the at least one receiving area comprises four receiving areas, one of the four receiving areas surrounding an extended terminal of the crisscross driving area respectively.

12. The control method of claim 8, wherein the step of coupling each of the at least one driving area in the plurality of touch sensing electrodes to the touch controller respectively, and coupling each of the at least one receiving area in the plurality of touch sensing electrodes to each other and then coupling the at least one driving area to the touch controller comprises:
coupling the at least one driving area and the at least one receiving area in the plurality of touch sensing electrodes to the touch controller with metal wires when the plurality of touch sensing electrodes are located behind a black matrix layer.

13. The control method of claim 8, wherein the step of scanning the at least one driving area in the plurality of touch sensing electrodes in order and detecting signals received by the at least one receiving area in the plurality of touch sensing electrodes by the touch controller, or scanning the at least one receiving area in the plurality of touch sensing electrodes in order and detecting signals received by the at least one driving area in the plurality of touch sensing electrodes by the touch controller comprises:
detecting a capacitance variation between the at least one driving area and the at least one receiving area in each of the plurality of touch sensing electrodes by the touch controller, in order to determine whether a touch gesture occurs and a location of the touch gesture.

14. The control method of claim 13, wherein when the capacitance variation exceeds a predetermined value, the touch controller determines that the touch gesture occurs, and the location of the touch gesture is calculated by interpolation according to capacitance variations in all of the plurality of touch sensing electrodes on the basis of a touch sensing electrode having a maximum capacitance variation among the plurality of touch sensing electrodes.
